(19) United States
(12) Patent Application Publication
(10) Pub. No.: US 2023/0008616 A1
(43) Pub. Date: Jan. 12, 2023

(54) METHOD AND SYSTEM FOR MONITORING, REPORTING AND NOTIFICATION OF CLOUD PLATFORM SYSTEM VARIABLES AND EVENTS

(71) Applicant: TENCENT AMERICA LLC, Palo Alto, CA (US)

(72) Inventor: Iraj SODAGAR, Los Angeles, CA (US)

(73) Assignee: TENCENT AMERICA LLC, Palo Alto, CA (US)

(21) Appl. No.: 17/704,707

(22) Filed: Mar. 25, 2022

Related U.S. Application Data
(60) Provisional application No. 63/218,803, filed on Jul. 6, 2021.

(51) Int. Cl. H04L 47/80; H04L 67/10

(52) U.S. Cl. CPC H04L 47/801; H04L 67/10

(57) ABSTRACT

Systems and methods for monitoring, reporting, and notification of media processing entities using system variables and events are provided. According to embodiments, schemes for the monitoring, reporting, and notification may be created, updated, and deleted using a media processing entity (MPE) application programming interface (API). According to embodiments, based on the scheme being implemented by an MPE, a value of a variable of the MPE or a status of an event of the MPE, during the monitoring, or as a part of the reporting, or as a part of the notification may be sent by the MPE and received.

### CROSS-REFERENCE TO RELATED APPLICATION

This application claims priority from U.S. Provisional Application No. 63/218,803, filed on Jul. 6, 2021 the disclosure of which is incorporated herein by reference in its entirety.

### FIELD

Embodiments of the present disclosure are directed to a set of systems and methods for monitoring, reporting, and notification of cloud platforms using system variables and events.

### BACKGROUND

Network and cloud platforms are used to run various applications. While the network-based media processing (NBMP) standard defines a method for discovery of a cloud platform's capabilities, it does not currently support the possibility of monitoring, reporting, and receiving notifications based on cloud platform system-level variables and events.

Also, while it may be possible to discover a cloud node's capabilities, there was previously no method to set up monitoring, reporting, and notifications using a node's system variables and events.

### SUMMARY

Embodiments of the present disclosure extend NBMP application programming interfaces (APIs) for setting up, updating, and destroying monitoring, reporting, and notification schemes that inform the values of variables and events.

According to embodiments, a method performed by at least one processor that implements a network-based media processing (NBMP) workflow manager may be provided. The method includes: causing a media processing entity (MPE) to perform at least one from among monitoring, reporting, and notification by sending, using an NBMP MPE application programming interface (API), a request to the MPE to implement a scheme of the at least one from among the monitoring, the reporting, and the notification; and receiving, from the MPE based on the scheme being implemented, a value of an MPE variable or a status of an event of the MPE, during the monitoring, or as a part of the reporting, or as a part of the notification, wherein the request includes at least one from among the MPE variable, which includes at least one MPE capability, and the event of the MPE.

According to one or more embodiments, the method further includes: requesting, using the NBMP MPE API, the MPE to update the scheme.

According to one or more embodiments, the method further includes: sending a request to the MPE, using the NBMP MPE API, to destroy the scheme.

According to one or more embodiments, the MPE variable is a system-level variable of the MPE, and the event is a system-level event of the MPE.

According to one or more embodiments, the method further includes: receiving a response to the request from the MPE that indicates whether the MPE successfully implemented the scheme.

According to one or more embodiments, the method further includes: sending a request to the MPE, using the NBMP MPE API, to retrieve MPE capabilities.

According to one or more embodiments, the sending the request to the MPE to retrieve the MPE capabilities comprises sending an MPE Capabilities Description to the MPE, the MPE Capabilities Description including a first descriptor that includes MPE implementation-specific variables of the MPE.

According to one or more embodiments, the MPE Capabilities Description further includes a second descriptor that lists the MPE capabilities, wherein the MPE implementation-specific variables of the first descriptor are not included in the second descriptor.

According to one or more embodiments, the MPE implementation-specific variables indicate hardware capabilities of the MPE.

According to one or more embodiments, the method further includes receiving, from the MPE, a response to the request to retrieve the MPE capabilities, wherein the response includes an updated version of the MPE Capabilities Description.

According to embodiments, a system is provided. The system includes: at least one memory configured to store computer program code; and at least one processor configured to access the computer program code and operate as instructed by the computer program code. The computer program code includes: creation request code configured to cause a network-based media processing (NBMP) workflow manager, implemented by the at least one processor, to cause a media processing entity (MPE) to perform at least one from among monitoring, reporting, and notification by sending, using an NBMP MPE application programming interface (API), a request to the MPE to implement a scheme of the least one from among the monitoring, the reporting, and the notification; and obtaining code configured to cause the NBMP workflow manager to obtain, from the MPE based on the scheme being implemented, a value of an MPE variable or a status of an event of the MPE, during the monitoring, or as a part of the reporting, or as a part of the notification, wherein the request includes at least one from among the MPE variable, which includes at least one MPE capability, and the event of the MPE.

According to one or more embodiments, the computer program code further includes update request code configured to cause the NBMP workflow manager to request, using the NBMP MPE API, the MPE to update the scheme.

According to one or more embodiments, the computer program code further includes delete request code configured to cause the NBMP workflow manager to send a request to the MPE, using the NBMP MPE API, to destroy the scheme.

According to one or more embodiments, the MPE variable is a system-level variable of the MPE, and the event is a system-level event of the MPE.

According to one or more embodiments, the computer program code further includes capabilities request code configured to cause the NBMP workflow manager to send a request to the MPE, using the NBMP MPE API, to retrieve MPE capabilities.

According to one or more embodiments, the capabilities request code is configured to cause the NBMP workflow manager to send an MPE Capabilities Description to the MPE, the MPE Capabilities Description includes a first descriptor that includes MPE implementation-specific variables of the MPE.

According to one or more embodiments, the MPE Capabilities Description further includes a second descriptor that lists the MPE capabilities, wherein the MPE implementation-specific variables of the first descriptor are not included in the second descriptor.

According to one or more embodiments, the MPE implementation-specific variables indicate hardware capabilities of the MPE.

According to embodiments, a non-transitory computer-readable medium storing computer code is provided. The computer code configured to, when executed by at least one processor, cause the at least one processor to implement a network-based media processing (NBMP) workflow manager that: causes a media processing entity (MPE) to perform at least one from among monitoring, reporting, and notification by sending, using an NBMP MPE application programming interface (API), a request to the MPE to implement a scheme of the at least one from among the monitoring, the reporting, and the notification; and receives, from the MPE based on the scheme being implemented, a value of an MPE variable or a status of an event of the MPE, during the monitoring, or as a part of the reporting, or as a part of the notification, wherein the request includes at least one from among the MPE variable, which includes at least one MPE capability, and the event of the MPE.

According to one or more embodiments, the computer code is further configured to cause the NBMP workflow manager to request, using the NBMP MPE API, the MPE to update the scheme.

### BRIEF DESCRIPTION OF THE DRAWINGS

Further features, the nature, and various advantages of the disclosed subject matter will be more apparent from the following detailed description and the accompanying drawings in which:

FIG. 1 is a diagram of an environment in which methods, apparatuses, and systems described herein may be implemented, according to embodiments.

FIG. 2 is a block diagram of example components of one or more devices of FIG. 1.

FIG. 3 is a block diagram of an NBMP system according to embodiments.

FIG. 4 is a block diagram of computer code according to embodiments.

### DETAILED DESCRIPTION

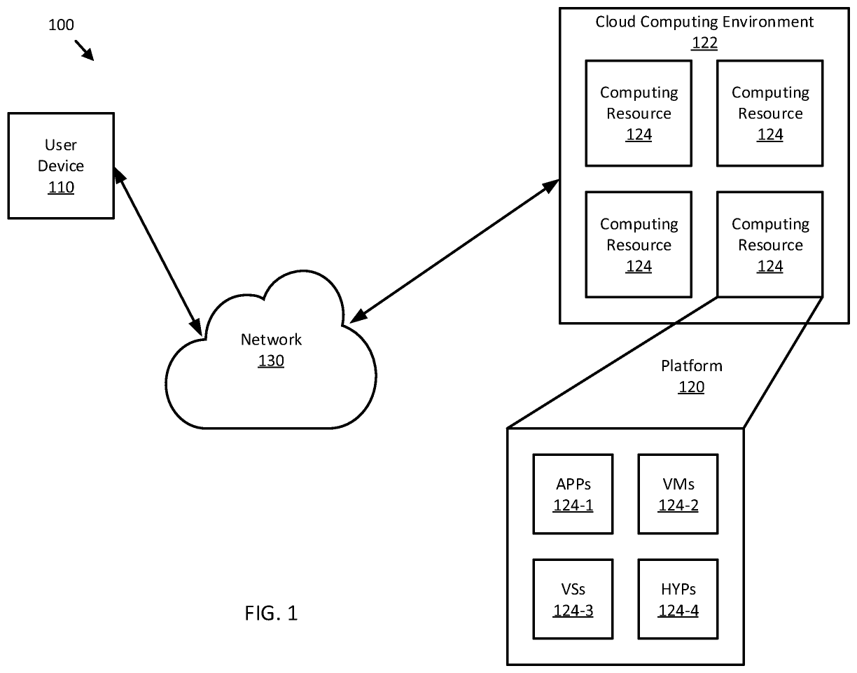

FIG. 1 is a diagram of an environment 100 in which methods, apparatuses, and systems described herein may be implemented, according to embodiments. As shown in FIG. 1, the environment 100 may include a user device 110, a platform 120, and a network 130. Devices of the environment 100 may interconnect via wired connections, wireless connections, or a combination of wired and wireless connections.

The user device 110 includes one or more devices capable of receiving, generating, storing, processing, and/or providing information associated with platform 120. For example, the user device 110 may include a computing device (e.g., a desktop computer, a laptop computer, a tablet computer, a handheld computer, a smart speaker, a server, etc.), a mobile phone (e.g., a smart phone, a radiotelephone, etc.), a wearable device (e.g., a pair of smart glasses or a smart watch), or a similar device. In some implementations, the user device 110 may receive information from and/or transmit information to the platform 120.

The platform 120 includes one or more devices as described elsewhere herein. In some implementations, the platform 120 may include a cloud server or a group of cloud servers. In some implementations, the platform 120 may be designed to be modular such that software components may be swapped in or out depending on a particular need. As such, the platform 120 may be easily and/or quickly reconfigured for different uses.

In some implementations, as shown, the platform 120 may be hosted in a cloud computing environment 122. Notably, while implementations described herein describe the platform 120 as being hosted in the cloud computing environment 122, in some implementations, the platform 120 may not be cloud-based (i.e., may be implemented outside of a cloud computing environment) or may be partially cloud-based.

The cloud computing environment 122 includes an environment that hosts the platform 120. The cloud computing environment 122 may provide computation, software, data access, storage, etc. services that do not require end-user (e.g., the user device 110) knowledge of a physical location and configuration of system(s) and/or device(s) that hosts the platform 120. As shown, the cloud computing environment 122 may include a group of computing resources 124 (referred to collectively as “computing resources 124” and individually as “computing resource 124”).

The computing resource 124 includes one or more personal computers, workstation computers, server devices, or other types of computation and/or communication devices. In some implementations, the computing resource 124 may host the platform 120. The cloud resources may include compute instances executing in the computing resource 124, storage devices provided in the computing resource 124, data transfer devices provided by the computing resource 124, etc. In some implementations, the computing resource 124 may communicate with other computing resources 124 via wired connections, wireless connections, or a combination of wired and wireless connections.

As further shown in FIG. 1, the computing resource 124 includes a group of cloud resources, such as one or more applications (“APPs”) 124-1, one or more virtual machines (“VMs”) 124-2, virtualized storage (“VSs”) 124-3, one or more hypervisors (“HYPs”) 124-4, or the like.

The application 124-1 includes one or more software applications that may be provided to or accessed by the user device 110 and/or the platform 120. The application 124-1 may eliminate a need to install and execute the software applications on the user device 110. For example, the application 124-1 may include software associated with the platform 120 and/or any other software capable of being provided via the cloud computing environment 122. In some implementations, one application 124-1 may send/receive information to/from one or more other applications 124-1, via the virtual machine 124-2.

The virtual machine 124-2 includes a software implementation of a machine (e.g., a computer) that executes programs like a physical machine. The virtual machine 124-2 may be either a system virtual machine or a process virtual machine, depending upon use and degree of correspondence to any real machine by the virtual machine 124-2. A system virtual machine may provide a complete system platform that supports execution of a complete operating system (“OS”). A process virtual machine may execute a single program, and may support a single process. In some implementations, the virtual machine 124-2 may execute on behalf of a user (e.g., the user device 110), and may manage infrastructure of the cloud computing environment 122, such as data management, synchronization, or long-duration data transfers.

The virtualized storage 124-3 includes one or more storage systems and/or one or more devices that use virtualization techniques within the storage systems or devices of the computing resource 124. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

The hypervisor 124-4 may provide hardware virtualization techniques that allow multiple operating systems (e.g., “guest operating systems”) to execute concurrently on a host computer, such as the computing resource 124. The hypervisor 124-4 may present a virtual operating platform to the guest operating systems, and may manage the execution of the guest operating systems. Multiple instances of a variety of operating systems may share virtualized hardware resources.

The network 130 includes one or more wired and/or wireless networks. For example, the network 130 may include a cellular network (e.g., a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, or the like, and/or a combination of these or other types of networks.

The number and arrangement of devices and networks shown in FIG. 1 are provided as an example. In practice, there may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) of the environment 100 may perform one or more functions described as being performed by another set of devices of the environment 100.

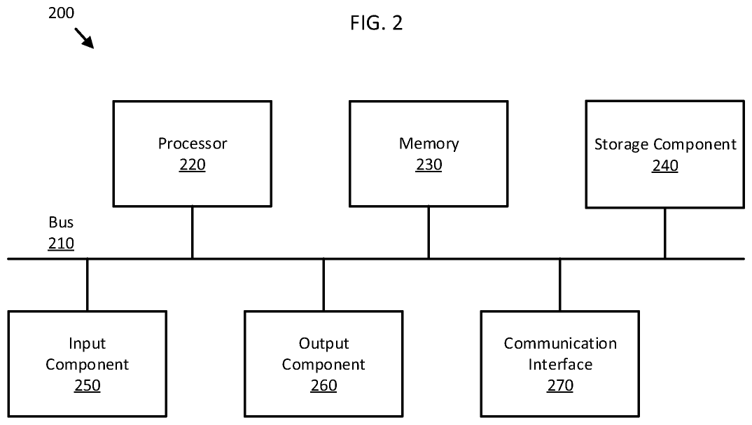

FIG. 2 is a block diagram of example components of one or more devices of FIG. 1. The device 200 may correspond to the user device 110 and/or the platform 120. As shown in FIG. 2, the device 200 may include a bus 210, a processor 220, a memory 230, a storage component 240, an input component 250, an output component 260, and a communication interface 270.

The bus 210 includes a component that permits communication among the components of the device 200. The processor 220 is implemented in hardware, firmware, or a combination of hardware and software. The processor 220 is a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, the processor 220 includes one or more processors capable of being programmed to perform a function. The memory 230 includes a random access memory (RAM), a read only memory (ROM), and/or another type of dynamic or static storage device (e.g., a flash memory, a magnetic memory, and/or an optical memory) that stores information and/or instructions for use by the processor 220.

The storage component 240 stores information and/or software related to the operation and use of the device 200. For example, the storage component 240 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

The input component 250 includes a component that permits the device 200 to receive information, such as via user input (e.g., a touch screen display, a keyboard, a keypad, a mouse, a button, a switch, and/or a microphone). Additionally, or alternatively, the input component 250 may include a sensor for sensing information (e.g., a global positioning system (GPS) component, an accelerometer, a gyroscope, and/or an actuator). The output component 260 includes a component that provides output information from the device 200 (e.g., a display, a speaker, and/or one or more light-emitting diodes (LEDs)).

The communication interface 270 includes a transceiver-like component (e.g., a transceiver and/or a separate receiver and transmitter) that enables the device 200 to communicate with other devices, such as via a wired connection, a wireless connection, or a combination of wired and wireless connections. The communication interface 270 may permit the device 200 to receive information from another device and/or provide information to another device. For example, the communication interface 270 may include an Ethernet interface, an optical interface, a coaxial interface, an infrared interface, a radio frequency (RF) interface, a universal serial bus (USB) interface, a Wi-Fi interface, a cellular network interface, or the like.

The device 200 may perform one or more processes described herein. The device 200 may perform these processes in response to the processor 220 executing software instructions stored by a non-transitory computer-readable medium, such as the memory 230 and/or the storage component 240. A computer-readable medium is defined herein as a non-transitory memory device. A memory device includes memory space within a single physical storage device or memory space spread across multiple physical storage devices.

Software instructions may be read into the memory 230 and/or the storage component 240 from another computer-readable medium or from another device via the communication interface 270. When executed, software instructions stored in the memory 230 and/or the storage component 240 may cause the processor 220 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 2 are provided as an example. In practice, the device 200 may include additional components, fewer components, different components, or differently arranged components than those shown in FIG. 2. Additionally, or alternatively, a set of components (e.g., one or more components) of the device 200 may perform one or more functions described as being performed by another set of components of the device 200.

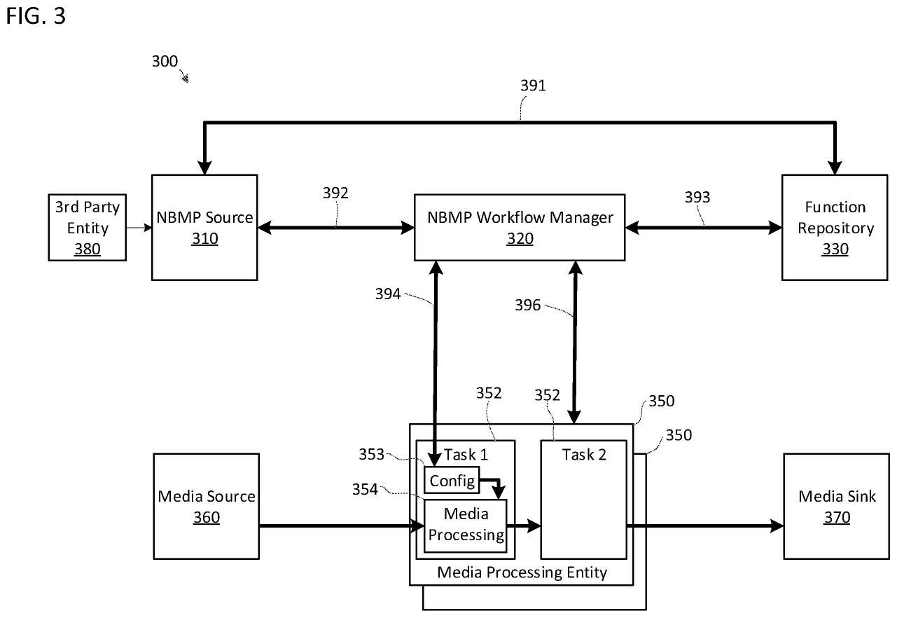

In an embodiment of the present disclosure, an NBMP system 300 is provided. With reference to FIG. 3, the NBMP system 300 comprises an NBMP source 310, an NBMP workflow manager 320, a function repository 330, one or more media processing entities (MPEs) 350, a media source 360, and a media sink 370.

The NBMP source 310 may receive instructions from a third party entity 380, may communicate with the NBMP workflow manager 320 via an NBMP workflow API 392, and may communicate with the function repository 330 via a function discovery API 391. For example, the NBMP source 310 may send a workflow description document(s) (WDD) to the NBMP workflow manager 320, and may read the function description of functions stored in the function repository 330, the functions being media processing functions stored in memory of the function repository 330 such as, for example, functions of media decoding, feature point extraction, camera parameter extraction, projection method, seam information extraction, blending, post-processing, and encoding. The NBMP source 310 may comprise or be implemented by at least one processor and memory that stores code configured to cause the at least processor to perform the functions of the NBMP source 310.

The NBMP source 310 may request the NBMP workflow manager 320 to create workflow including tasks 352 to be performed by the one or more media processing entities 350 by sending the workflow description document, which may include several descriptors, each of which may have several parameters.

For example, the NBMP source 310 may select functions stored in the function repository 330 and send the workflow description document to the NBMP workflow manager 320 that includes a variety of descriptors for description details such as input and output data, required functions, and requirements for the workflow. The workflow description document may include a set of task descriptions and a connection map of inputs and outputs of tasks 352 to be performed by one or more of the media processing entities 350. When the NBMP workflow manager 320 receives such information from the NBMP source 310, the NBMP workflow manager 320 may create the workflow by instantiating the tasks based on function names and connecting the tasks in accordance with the connection map.

Alternatively or additionally, the NBMP source 310 may request the NBMP workflow manager 320 to create workflow by using a set of keywords. For example, NBMP source 310 may send the NBMP workflow manager 320 the workflow description document that may include a set of keywords that the NBMP workflow manager 320 may use to find appropriate functions stored in the function repository 330. When the NBMP workflow manager 320 receives such information from the NBMP source 310, the NBMP workflow manager 320 may create the workflow by searching for appropriate functions using the keywords that may be specified in a Processing Descriptor of the workflow description document, and use the other descriptors in the workflow description document to provision tasks and connect them to create the workflow.

The NBMP workflow manager 320 may communicate with the function repository 330 via a function discovery API 393, which may be a same or different API from the function discovery API 391, and may communicate with one or more of the media processing entities 350 via an NBMP task API 394. The NBMP workflow manager 320 may also communicate with one or more of the media processing entities 350 via a media processing entity (MPE) API 396. The NBMP workflow manager 320 may comprise or be implemented by at least one processor and memory that stores code configured to cause the at least processor to perform the functions of the NBMP workflow manager 320.

The NBMP workflow manager 320 may use the NBMP task API 394 to setup, configure, manage, and monitor one or more tasks 352 of a workflow that is performable by the one or more media processing entities 350. In an embodiment, the NBMP workflow manager 320 may use the NBMP task API 394 to update and destroy the tasks 352. In order to configure, manage, and monitor tasks 352 of the workflow, the NBMP workflow manager 320 may send messages, such as requests, to one or more of the media processing entities 350, wherein each message may have several descriptors, each of which have several parameters. The tasks 352 may each include media processing functions 354 and configurations 353 for the media processing functions 354.

In an embodiment, after receiving a workflow description document from the NBMP source 310 that does not include a list of the tasks (e.g., includes a list of keywords instead of a list of tasks), the NBMP workflow manager 320 may select the tasks based on the descriptions of the tasks in the workflow description document to search the function repository 330, via the function discovery API 393, to find the appropriate functions to run as tasks 352 for a current workflow. For example, the NBMP workflow manager 320 may select the tasks based on keywords provided in the workflow description document. After the appropriate functions are identified by using the keywords or the set of task descriptions that is provided by the NBMP source 310, the NBMP workflow manager 320 may configure the selected tasks in the workflow by using the NBMP task API 394. For example, the NBMP workflow manager 320 may extract configuration data from information received from the NBMP source, and configure the tasks 352 based on the configuration data.

The one or more media processing entities 350 may be configured to receive media content from the media source 360, process the media content in accordance with the workflow, that includes tasks 352, created by the NBMP workflow manager 320, and output the processed media content to the media sink 370. The one or more media processing entities 350 may each comprise or be implemented by at least one processor and memory that stores code configured to cause the at least processor to perform the functions of the media processing entities 350.

The media source 360 may include memory that stores media and may be integrated with or separate from the NBMP source 310. In an embodiment, the NBMP workflow manager 320 may notify the NBMP source 310 when a workflow is prepared and the media source 360 may transmit media content to the one or more of the media processing entities 350 based on the notification that the workflow is prepared.

The media sink 370 may comprise or be implemented by at least one processor and at least one display that is configured to display the media that is processed by the one or more media processing entities 350.

The third party entity 380 may comprise or be implemented by at least one processor and memory that stores code configured to cause the at least processor to perform the functions of the third party entity 380.

As discussed above, messages from the NBMP Source 310 (e.g., a workflow description document for requesting creation of a workflow) to the NBMP workflow manager 320, and messages (e.g., for causing the workflow to be performed) from the NBMP workflow manager 320 to the one or more media processing entities 350 may include several descriptors, each of which may have several parameters. In cases, communication between any of the components of the NBMP system 300 using an API may include several descriptors, each of which may have several parameters.

According to embodiments, an MPE Capabilities Description (MD) may be provided. The MD may include a set of descriptors for describing capabilities of an MPE. The MD may be included in CDAM2 as shown below in TABLE 1.

TABLE 1
MPE Capabilities Description (MD)

| Descriptor | Additional constraints | Cardinality |
|---|---|---|
| Scheme | None | 0-1 |
| General | The ‘id’ may be required to be unique | 1 |
| | among all MPEs, including Source and Sink. | |
| | The following parameters may be required | |
| | to not be present: | |
| | rank | |
| | published-time | |
| | priority | |
| | input-ports | |
| | output-ports | |
| | is-group | |
| | state | |
| Capabilities | This descriptor is used to describe the | 0-1 |
| | capabilities: | |
| Events | This descriptor lists events in the case of | 0-1 |
| | changed resource capabilities such as the | |
| | parameters defined in the Capabilities | |
| | Descriptor. | |

Cardinality: 1 = exactly one, 0-1 = zero or one

Additionally, only a retrieve capabilities operation may be defined in task configuration API. The retrieve capabilities operation of the task configuration API is shown below in TABLE 2.

TABLE 2
Task Configuration API

| | | Request resource | |
|---|---|---|---|
| Operation | Description | requirements | Response Requirements |
| Retrieve | Retrieve | MD with identical | If successful, shall |
| Capabilities | Capabilities | General’s id, and | include: |
| | of MPE | optionally the | 1) HTTP status code 2 01 |
| | | desired list of | 2) Response’s body with |
| | | MPE’s ids/urls | updated MD including: |
| | | | a) General descriptor’s |
| | | | identical to the one in |
| | | | the request |
| | | | b) Updated capability |
| | | | information |
| | | | If failed, shall include: |
| | | | 1) HTTP status codes |
| | | | 4xx or 5xx |
| | | | 2) Optionally, response’s |
| | | | body with updated MD |
| | | | signalling failed |
| | | | descriptors or parameters |

The current NBMP specification supports system-variables and system-events in Monitoring, Reporting, and Notification Descriptors. However, these descriptors are designed for functions, and an image of a function does not necessarily have information about the system variables and events of the MPE that is being run on.

It is much more practical to separately set up the monitoring, reporting, and notification of system variables and events through MPE and independent of the tasks.

While the inclusion of the Events descriptor in MD is useful to describe the events that the MPE can support, there is no mechanism previously defined for the NBMP workflow manager to set up events reporting or notifications. It is beneficial for the NBMP workflow manager to be capable of setting the reporting or notification for a desired subset of MPE events. MPE events describe the system-level events which are independent of the functions' events running on the MPE. According to embodiments, the system-level events may include the bare hardware capabilities of the MPE.

Additionally, a cloud platform/MPE might have variables that are not described in the Capabilities Descriptor. Previously, there has been no mechanism to (1) describe those variables and (2) add the variables for reporting and notifications. Previously, those variables could not be monitored by the NBMP workflow manager either.

Embodiments of the present disclosure may provide a solution to the above problems and/or other problems.

Embodiments of the present disclosure may include the following improvements:
1. Add a variable descriptor to the MPE Capabilities Description, so that MPE specific variables can be discovered as part of the MPE capabilities. According to embodiments, the MPE specific variables may include hardware capabilities of MPE such as, for example, CPU cycles, GPU cycles, bandwidth, and memory.
2. Add “create,” “update,” and “destroy” operations for setting up, updating, and destroying reporting and notification schemes for an MPE by the NBMP Workflow Manager, similar to the methods used in Task API.
3. Add the capability of retrieving a subset of variables using the monitoring descriptor in RetrieveCapabilities API.

Embodiments of the present disclosure may extend existing MPE Capabilities Description with a Variable descriptor. For example, system-level variables may be added to MD using the Variable descriptor as shown below in TABLE 3.

TABLE 3
Extended MPE Capabilities Description (MD)

| Descriptor | Additional constraints | Cardinality |
|---|---|---|
| Scheme | None | 0-1 |
| General | The ‘id’ may be required to be unique | 1 |
| | among all MPEs, including Source and Sink. | |
| | The following parameters may be required | |
| | to not be present: | |
| | rank | |
| | published-time | |
| | priority | |
| | input-ports | |
| | output-ports | |
| | is-group | |
| | state | |
| Capabilities | This descriptor is used to describe the | 0-1 |
| | capabilities: | |
| Variables | This descriptor lists MPE implementation- | 0-1 |
| | specific variables that are not included in the | |
| | Capabilities Descriptor. | |
| | According to embodiments, the MPE | |
| | implementation-specific variables may | |
| | include hardware capabilities of MPE such | |
| | as, for example, CPU cycles, GPU cycles, | |
| | bandwidth, and memory. | |
| Events | This descriptor lists events in the case of | 0-1 |
| | changed resource capabilities such as the | |
| | parameters defined in the Capabilities | |
| | Descriptor. | |

Cardinality: 1 = exactly one, 0-1 = zero or one

Embodiments of the present disclosure may extend the MPE Capabilities API (also referred to herein as an MPE API) as discussed below.

According to embodiments, the MPE Capabilities API may include the following operations (1) CreateMPEMRN, (2) UpdateMPEMRN, (3) RetrieveCapabilities, (4) DeleteMPEMRN. According to embodiments, the operations may include a request resource, and a response. According to embodiments, the request resource may be sent from the NBMP workflow manager to one or more MPEs to perform the operation, and the response may be sent from the one or more MPEs to the NBMP workflow manager, wherein the response indicates whether the operation was successfully performed by the one or more MPEs.

The CreateMPEMRN operation may provide an MPE with the variables and events configuration for monitoring, reporting, and notifications. The operation may include a request resource that includes one or more from among following descriptors: Monitoring Descriptor, Reporting Descriptor, and Notification Descriptors. If the operation is successful, a response of the operation may be required to include HTTP status code 201, and the response's body to include an updated resource including the accepted variables and events in each corresponding descriptor provided in the request resource. If the operation fails, the response may be required to include HTTP status codes 4xx or 5xx, and, according to some embodiments, the response's body to include an updated resource that signals failed variables and/or events. According to embodiments, the CreateMPEMRN may also be referred to as a CreateMPEMonitoring, CreateMPEReporting, and CreateMPENotifications when only a respective one from the monitoring, reporting, and notifications schemes is requested to be created.

The UpdateMPEMRN operation may modify the configuration for MPE monitoring, reporting, and notification. The operation may include a request resource that includes an updated resource that was previously received in, for example, CreateMPEMonitoring's response (or, for example, CreateMPEMRN's response). If the operation is successful, a response of the operation may be required to include HTTP status code 201, and the response's body to include an updated resource including the accepted variables and events in each corresponding descriptor. If the operation fails, the response may be required to include HTTP status codes 4xx or 5xx, and, according to some embodiments, the response's body to include an updated resource that signals failed variables and/or events.

The RetrieveCapabilities operation may retrieve capabilities of the MPE. The operation may include a request resource that includes an MD with identical General's id and, according to some embodiments, a desired list of MPE's ids/urls. If the operation is successful, a response of the operation may be required to include HTTP status code 201, and the response's body with an updated MD including: (a) general descriptors identical to the one(s) in the request, and updated capability information. If the operation fails, the response may be required to include HTTP status codes 4xx or 5xx and, according to some embodiments, the response's body to include an updated MD that signals failed descriptors or parameters.

The DeleteMPEMRN operation may destroy monitoring, reporting, or notification schemes of MPE. The operation may include a request resource that includes the resource previously received in, for example, CreateMPEMonitoring's response (or, for example, CreateMPEMRN's response). If the operation is successful, a response of the operation may be required to include HTTP status code 200. If the operation fails, the response may be required to include HTTP status codes 4xx or 5xx and, according to some embodiments, the response's body to include an updated resource that signals failed descriptors/variables/events.

As described above, the MPE Capabilities API is extended with the operations of CreateMPEMRN, RetrieveCapabilities, and DeleteMPEMRN to enable creating, updating, and destroying schemes for monitoring, reporting, and notification of an MPE's variables and events.

According to embodiments, systems and methods may be provided that include a cloud platform's variables using NBMP MPE Capabilities Description, wherein system-specific variables are described as part of the MPE capabilities.

According to embodiments, systems and methods may be provided that include operations for setting up monitoring, reporting, and notification schemes for a cloud platform node by extending the NBMP MPE API to support creating, updating, and destroying the monitoring, reporting, and notification schemes for system-level variables and events of MPE that are discovered as part of the MPE capabilities discovery process, wherein the MPE can be set up to provide the values of variables and the status of events during monitoring, and/or as a part of regular reporting, and/or as part of notification when specific criteria are met, to notify an internal or external party with the values of the MPE's system variables and status of its events.

According to embodiments of the present disclosure, at least one processor with memory storing computer code may be provided. The computer code may be configured to, when executed by the at least one processor, perform any number of aspects of the present disclosure.

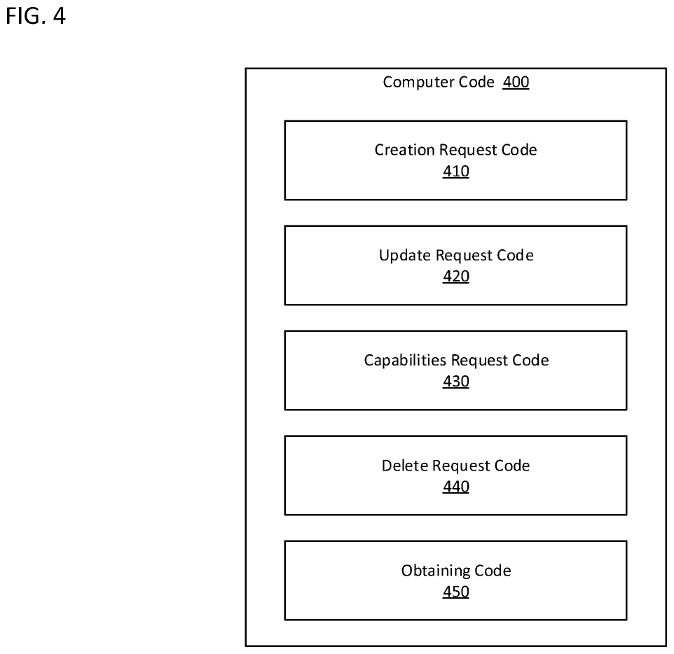

For example, with reference to FIG. 4, computer code 400 may be implemented in the NBMP system 300. For example, the computer code may be stored in memory of the NBMP workflow manager 320 and may be executed by at least one processor of the NBMP workflow manager 320. The computer code may comprise, for example, creation request code 410, update request code 420, capabilities request code 430, delete request code 440, and obtaining code 450.

The creation request code 410 may be configured to cause the NBMP workflow manager 320 to create and send a request to an MPE 350 to implement a scheme of at least one from among monitoring, reporting, and notification, in accordance with embodiments of the present disclosure. For example, the NBMP workflow manager 320 may implement the CreateMPEMRN operation of the MPE Capabilities API as described above. According to embodiments, the creation request code 410 may be configured to cause the NBMP workflow manager 320 to cause the MPE 350 to perform the at least one from among the monitoring, the reporting, and the notification by sending the request. The request may include at least one from an MPE variable and an event of the MPE 350, in accordance with embodiments of the present disclosure.

The update request code 420 may be configured to cause the NBMP workflow manager 320 to create and send a request to the MPE 350 to update the scheme, in accordance with embodiments of the present disclosure. For example, the NBMP workflow manager 320 may implement the UpdateMPEMRN operation of the MPE Capabilities API as described above.

The capabilities request code 430 may be configured to cause the NBMP workflow manager 320 to send a request to the MPE 350 to retrieve capabilities of the MPE 350, in accordance with embodiments of the present disclosure. For example, the NBMP workflow manager 320 may implement the RetrieveCapabilities operation of the MPE Capabilities API as described above.

The delete request code 440 may be configured to cause the NBMP workflow manager 320 to send a request to the MPE 350 to destroy the scheme, in accordance with embodiments of the present disclosure. For example, the NBMP workflow manager 320 may implement the DeleteMPEMRN operation of the MPE Capabilities API as described above.

The obtaining code 450 may be configured to cause the NBMP workflow manager 320 to obtain, from the MPE 350 after the scheme is implemented by the MPE 350, a value of a variable of the MPE 350 or a status of an event of the MPE 350, during the monitoring, or as a part of the reporting, or as a part of the notification, in accordance with embodiments of the present disclosure. According to embodiments, the obtaining code 450 may be further configured to cause the NBMP workflow manager 320 to obtain responses (and information therein) from the MPE 350, in response to the requests of the operations of the CreateMPEMRN, UpdateMPEMRN, RetrieveCapabilities, and DeleteMPEMRN, in accordance with embodiments of the present disclosure.

According to one or more embodiments, embodiments of the present disclosure may be implemented in environments different from NBMP.

The foregoing disclosure provides illustration and description, but is not intended to be exhaustive or to limit the implementations to the precise form disclosed. Modifications and variations are possible in light of the above disclosure or may be acquired from practice of the implementations.

As used herein, the term component is intended to be broadly construed as hardware, firmware, or a combination of hardware and software.

Even though combinations of features are recited in the claims and/or described in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Furthermore, as used herein, the term “set” is intended to include one or more items (e.g., related items, unrelated items, a combination of related and unrelated items, etc.), and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

What is claimed is:

1. A method performed by at least one processor that implements a network-based media processing (NBMP) workflow manager, the method comprising:
causing a media processing entity (MPE) to perform at least one from among monitoring, reporting, and notification by sending, using an NBMP MPE application programming interface (API), a request to the MPE to implement a scheme of the at least one from among the monitoring, the reporting, and the notification; and
receiving, from the MPE based on the scheme being implemented, a value of an MPE variable or a status of an event of the MPE, during the monitoring, or as a part of the reporting, or as a part of the notification,
wherein the request includes at least one from among the MPE variable, which includes at least one MPE capability, and the event of the MPE.

2. The method of claim 1, further comprising requesting, using the NBMP MPE API, the MPE to update the scheme.

3. The method of claim 1, further comprising sending a request to the MPE, using the NBMP MPE API, to destroy the scheme.

4. The method of claim 1, wherein the MPE variable is a system-level variable of the MPE, and the event is a system-level event of the MPE.

5. The method of claim 1, further comprising receiving a response to the request from the MPE that indicates whether the MPE successfully implemented the scheme.

6. The method of claim 1, further comprising sending a request to the MPE, using the NBMP MPE API, to retrieve MPE capabilities.

7. The method of claim 6, wherein the sending the request to the MPE to retrieve the MPE capabilities comprises sending an MPE Capabilities Description to the MPE, the MPE Capabilities Description including a first descriptor that includes MPE implementation-specific variables of the MPE.

8. The method of claim 7, wherein the MPE Capabilities Description further includes a second descriptor that lists the MPE capabilities, wherein the MPE implementation-specific variables of the first descriptor are not included in the second descriptor.

9. The method of claim 7, wherein the MPE implementation-specific variables indicate hardware capabilities of the MPE.

10. The method of claim 7, further comprising receiving, from the MPE, a response to the request to retrieve the MPE capabilities, wherein the response includes an updated version of the MPE Capabilities Description.

11. A system comprising:
at least one memory configured to store computer program code; and
at least one processor configured to access the computer program code and operate as instructed by the computer program code, the computer program code comprising:
creation request code configured to cause a network-based media processing (NBMP) workflow manager, implemented by the at least one processor, to cause a media processing entity (MPE) to perform at least one from among monitoring, reporting, and notification by sending, using an NBMP MPE application programming interface (API), a request to the MPE to implement a scheme of the least one from among the monitoring, the reporting, and the notification; and
obtaining code configured to cause the NBMP workflow manager to obtain, from the MPE based on the scheme being implemented, a value of an MPE variable or a status of an event of the MPE, during the monitoring, or as a part of the reporting, or as a part of the notification,
wherein the request comprises at least one from among the MPE variable, which comprises at least one MPE capability, and the event of the MPE.

12. The system of claim 11, wherein the computer program code further comprises update request code configured to cause the NBMP workflow manager to request, using the NBMP MPE API, the MPE to update the scheme.

13. The system of claim 11, wherein the computer program code further comprises delete request code configured to cause the NBMP workflow manager to send a request to the MPE, using the NBMP MPE API, to destroy the scheme.

14. The system of claim 11, wherein the MPE variable is a system-level variable of the MPE, and the event is a system-level event of the MPE.

15. The system of claim 11, wherein the computer program code further comprises capabilities request code configured to cause the NBMP workflow manager to send a request to the MPE, using the NBMP MPE API, to retrieve MPE capabilities.

16. The system of claim 15, wherein the capabilities request code is configured to cause the NBMP workflow manager to send an MPE Capabilities Description to the MPE, the MPE Capabilities Description comprises a first descriptor that includes MPE implementation-specific variables of the MPE.

17. The system of claim 16, wherein the MPE Capabilities Description further comprises a second descriptor that lists the MPE capabilities, wherein the MPE implementation-specific variables of the first descriptor are not included in the second descriptor.

18. The system of claim 16, wherein the MPE implementation-specific variables indicate hardware capabilities of the MPE.

19. A non-transitory computer-readable medium storing computer code that is configured to, when executed by at least one processor, cause the at least one processor to implement a network-based media processing (NBMP) workflow manager that:
causes a media processing entity (MPE) to perform at least one from among monitoring, reporting, and notification by sending, using an NBMP MPE application programming interface (API), a request to the MPE to implement a scheme of the at least one from among the monitoring, the reporting, and the notification; and
receives, from the MPE based on the scheme being implemented, a value of an MPE variable or a status of an event of the MPE, during the monitoring, or as a part of the reporting, or as a part of the notification,
wherein the request includes at least one from among the MPE variable, which includes at least one MPE capability, and the event of the MPE.

20. The non-transitory computer-readable medium of claim 19, wherein the computer code is further configured to cause the NBMP workflow manager to request, using the NBMP MPE API, the MPE to update the scheme.
